(19) United States
(12) Patent Application Publication
(10) Pub. No.: US 2010/0310725 A1
(43) Pub. Date: Dec. 9, 2010

(54) NUTRITIONALLY APPROPRIATE MENU OF FOOD PRODUCTS FOR CHILDREN

(76) Inventors: Kathleen Reidy, West Orange, NJ (US); Cheryl Callen, Short Hills, NJ (US); Lynn Belote, Denville, NJ (US)

Correspondence Address: Gerber Products Company, 12 Vreeland Road, 2nd Floor, Box 697, Florham Park, NJ, 07932, US

(21) Appl. No.: 12/746,861

(22) PCT Filed: Dec. 23, 2008
(86) PCT No.: PCT/US08/14012

§ 371 Date: Aug. 25, 2010

Related U.S. Application Data
(60) Provisional application No. 61/018,087, filed on Dec. 31, 2007.
(60) Provisional application No. 61/018,110, filed on Dec. 31, 2007.

(51) Int. Cl. A23L 1/30; A23L 1/308; A23L 1/304; A23D 9/00

(52) U.S. Cl. 426/87; 426/601; 426/648; 426/649

(57) ABSTRACT

The present invention provides a nutritional methodology for optimizing the nutritional needs of a child that includes suggested combinations of food products from a range of foods having an optimal nutrition profile for meeting the nutritional needs of a child wherein two or more food products from the range may be combined to provide an optimal nutrition profile for meeting the nutritional needs of a child. The present invention further provides a kit and a shelf-stable product that employ the nutritional method for optimizing the nutritional needs of a child.

### FIELD OF THE INVENTION

The present invention relates generally to shelf-stable toddler foods and particularly to menus of shelf-stable toddler foods which have an optimal nutrition profile for meeting the nutritional needs of a toddler.

### BACKGROUND OF THE INVENTION

As is well known, good nutrition in childhood can provide a foundation for good health throughout the lifetime of a person or an individual, and can also help to prevent. There are six categories of nutrients that the human body needs to acquire from food, namely, protein, carbohydrates, fat, fibers, vitamins and minerals, and water. The United States Department of Agriculture recommends for children age two or older, that 55% of their caloric intake should be in form of carbohydrates, 30% from fat, and 15% from protein. In addition, saturated fat intake should not exceed 10% of the total caloric intake. Accordingly, parents should closely monitor their childrens' diets, avoiding high levels of fat (should be less than 30% of the calorie intake), cholesterol, sugar, and salt, as well as maintaining adequate intake of vitamins, minerals and other nutrients. In addition, a healthy nutritional diet should contain less than 300 milligrams of cholesterol, less than 65 grams of total fat, less than 20 grams of saturated fat and less than 2,400 milligrams of sodium.

When the Nutrition Labeling and Education Act (NLEA) was enacted in 1993, there was a reluctance, based on the dietary recommendations at that time, to develop Daily Values (DV) for fat, cholesterol, saturated fat and sodium for children up to four (4) years of age. Because there are no macronutrient DVs, but there are vitamin and mineral DVs, products labeled for children under the age of two (2) years are limited to good source for vitamins and minerals only. See 21 C.F.R. §101.

In the nearly sixteen years since the NLEA, childhood obesity has dramatically increased. In fact, Gerber Products Company's published study, entitled the Feeding Infants and Toddlers Study of 2002, found that trends in adult poor eating habits have their genesis in infant and toddler diets. As an example of toddler poor eating habits, approximately twenty five percent of toddlers did not eat a single fruit or vegetable in a given day. Sweetened drinks and candy were also part of the daily diet of twenty five percent of toddlers on a given day. These troublesome dietary trends, conjoined with current regulatory gaps in this sector, leave the makers of toddler products unable to clearly communicate nutrition benefits to caregivers.

Therefore, despite the wealth of information available over the Internet and otherwise on the care and feeding of infants and toddlers, there remains a need for an improved methodology for guiding caregivers to provide optimal nutrition to toddlers.

### SUMMARY OF THE INVENTION

The present invention provides a range of daily feeding schedules for children comprising suggested combinations of food products from a range of foods having an optimal nutrition profile for meeting the nutritional needs of a child, particularly where two or more food products from the range may be combined to provide an optimal nutrition profile for meeting the nutritional needs of a child.

In one embodiment, the present invention provides a nutrition method for optimizing the nutritional needs of a child that includes (1) ascertaining a caloric requirement for the child and (2) combining, from a selection of daily food components on a daily food component reference, at least two of the daily food components. The caloric requirement is based at least on the age of the child. The daily food components, each having a respective nutritional profile associated therewith, are selected from the group consisting of fat, saturated fat, trans fat, sodium, cholesterol, fiber and sugar. The combination of at least two daily food components have a caloric load about that of the caloric requirement for a meal for the child. In addition, the selection and combining of the daily food components pursuant to the teachings of the present invention optimize the nutritional needs of the child.

The child benefiting from the improvements of the present invention may be up to about five (5) years of age, between one and five years of age or between one and four (4) years of age.

As indicated, the daily food components combined may include fat, saturated fat, sodium and cholesterol. The fat may be at least about 41 gm; saturated fat may be at least about 12 g, sodium may be at least about 1500 mg and the cholesterol may be at least about 300 mg. In addition, the daily food components, when combined, may further include fiber that may be at least about 16 g.

The step of combining the selection of at least two of said daily food components may include an incomplete meal or a complete meal, wherein the complete meal may comprise of at least two incomplete meals.

In other embodiments, the present invention also provides (1) a kit allowing a parent or caregiver to better optimize the nutritional needs of a child, and (2) a shelf-stable food product that includes:

(a) a caloric reference, wherein the caloric reference provides a user with a caloric requirement for the child and the caloric requirement, which is based at least on the age of the child; and

(b) a daily food component reference, wherein the daily food component reference provides the user with a selection of daily food components, at least two of the daily food components being combined,

where the daily food components, each having a respective nutritional profile associated therewith, are selected from the group consisting of fat, saturated fat, trans fat, sodium, cholesterol, fiber and sugar, and where the combination of at least two daily food components have a caloric load about that of the caloric requirement for a meal of the child, whereby the selection and combining of the daily food components optimize the nutritional needs of the child.

As used herein, the term “comprise” and variations of the term, such as “comprising,” “comprises” and “comprised,” are not intended to exclude other additives, components, integers or steps.

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein.

It would be helpful to first set forth some definitions of terms employed in the present invention, providing some guidance in describing the advances of the instant innovation and increasing awareness of the benefits thereof.

“Toddlers,” as used in the instant specification, refer to children from the age of one to five years of age.

“Infants” refer to children up to the age of one year.

“Complete meal” refers to a meal that is designed to provide one nutritionally-balanced serving, i.e., it is not necessarily to combine the complete meal with another food product to provide a meal.

“Incomplete meal” therefore refers to a meal not satisfying the requirements of a Complete meal, but forming a portion thereof, i.e., upon combining two or more Incomplete meals, this corresponds to a Complete meal.

“Shelf-Stable food product” refers to food products that can be safely stored and sold in a sealed container at room temperature while still having a useful shelf life, for example at least about 2 months, preferably longer.

“Daily Value (DV),” established by the U.S. Food and Drug Administration (USFDA) in food and dietary labeling, refers to a reference point to assist people to get a perspective of what their overall daily dietary need should be, and indicates the percent of the recommended daily amount of each nutrient that a serving provides. The DV percentages (% DV) on food labels are based on a 2000 calorie intake for adults and children 4 years and older. Based on the personal calorie needs of a particular person, the DV may be higher or lower. The Daily Values, provided hereinbelow, are provided from the USFDA, Center for Food Safety and Applied Nutrition, A food Labeling Guide, September 1994 (Editorial Revisions, June 1999). The DV replaces the previous designation of the U.S. Recommended Dietary Allowances (RDAs).

The DVs are made up of two sets of references, DRVs and RDIs (Reference Daily Intake). The DRV (Daily Reference Values) are a set of dietary references that applies to fat, saturated fat, cholesterol, carbohydrate, protein, fiber, sodium and potassium. The RDIs (Reference Daily Intakes) are a set of dietary references based on the Recommended Dietary Allowances (RDAs) for essential vitamins and minerals and, in selected groups, protein. The RDAs, as further defined hereinbelow, are a set if nutrient allowances established by the National Academy of Sciences. The RDAs are a part of the DRIs.

For macronutrients, the Daily Values are as follows:

Macronutrients

| Nutrient | Daily Values | |
|---|---|---|
| Cholesterol | <300 | mg |
| Total | 300 | g |
| Carbohydrate | | |
| Dietary Fiber | 25 | g |
| Protein | 50 | g |
| Total Fat | <65 | g |
| Saturated Fat | <20 | g |

For micronutrients, such as vitamins and minerals, the Daily Values are as follows:

| | |
|---|---|
| Nutrient | Daily Values |

Vitamins

| | | |
|---|---|---|
| Vitamin C | 60 | mg |
| Thiamin | 1.5 | mg |
| Riboflavin | 1.7 | mg |
| Niacin | 20 | mg |
| Pathothenic | 10 | mg |
| Acid | | |
| Vitamin B6 | 2 | mg |
| Folate | 400 | mcg |
| Vitamin B12 | 6 | mcg |
| Vitamin A | 5000 | IU |
| Vitamin E | 30 | IU |
| Vitamin K | 80 | mcg |

Minerals

| | | |
|---|---|---|
| Calcium | 1000 | mg |
| Iodine | 150 | mcg |
| Iron | 18 | mg |
| Magnesium | 400 | mg |
| Phosphorus | 1000 | mg |
| Potassium | 3500 | mg |
| Sodium | <2400 | mg |
| Zinc | 15 | mg |
| Copper | 2 | mg |
| Manganese | 2 | mg |
| Selenium | 70 | mcg |

“Dietary Reference Intake (DRI)” is a system of nutrition recommendations from the Institute of Medicine (IOM) of the U.S. National Academy of Sciences. DRI system was introduced in 1997 to broaden the RDA guidelines. While the DRI values are not currently used in nutrition labeling, the older Reference Daily Intake (RDI) are still in use. There are four types of DRI reference values, namely, the Estimated Average Requirement (EAR), the Recommended Dietary Allowance (RDA), the Adequate Intake (AI) and the Tolerable Upper Intake Level (UL). The primary goal of having these new dietary reference values was to not only prevent nutrient deficiencies but also to lower the risk of chronic diseases such as osteoporosis, cancer and cardiovascular diseases. For additional information, please refer to Dietary Reference Intakes for Energy, Carbohydrate, Fiber, Fat, Fatty Acids, Cholesterol, Protein, and Amino Acids (Macronutrients), 2005, National Academy of Sciences. Institute of Medicine. Food and Nutrition Board or go to www.nal.usda.gov/fnic/DRIHDRI_Energy/energy_full_report.pdf.

“Estimated Average Requirement (EAR)” refers to a daily nutrient intake value that is estimated to meet the requirement of half of the healthy individuals in a life stage and gender group. EAR is used to assess dietary adequacy and as a basis for the RDA.

“Recommended Dietary Allowance (RDA)” refers to the average daily dietary intake level that is sufficient to meet the nutrient requirement of nearly all (97 to 98%) healthy individuals in a particular life-stage and gender group. An RDA for a given nutrient may vary depending on a person's age, sex and physical condition (e.g., pregnancy).

“Adequate Intake (AI)” refers to the recommended average daily nutrient intake level based on observed or experimentally determined approximations or estimates of nutrient intake by a group (or groups) of apparently healthy people who are assumed to be maintaining an adequate nutritional state.

“Tolerable Upper Intake Level (UL)” refers to the highest average daily nutrient intake level likely to pose no risk of adverse health effects to almost all individuals in a given life-stage and gender group. The UL is not a recommended level of intake.

“Estimated Energy Requirement (EER)” refers to the average dietary energy intake that is predicted to maintain energy balance in healthy, normal weight individuals if a defined age, gender, weight, height and level of physical activity consistent with good health. In children and pregnant and lactating women, the EER includes the needs associated with growth or secretion of milk rates consistent with good health. Relative body weight (i.e., loss, stable, gain) is the preferred indicator of energy adequacy.

The DRI values, as recommended intakes and ULs for infants and toddlers, for vitamins and elements are available at www.iom.edu and www.nap.edu and summarized hereinbelow in the following charts, some of which due to their size have been divided into two parts but which should be read as one:

Dietary Reference Intakes (DRIs): Recommended Intakes for Individuals Vitamins
Food and Nutrition Board, Institute of Medicine, National Academies - Part 1

| Life Stage | Vit A | Vit C | Vit D | Vit E | Vit K | Thiamin | Riboflavin |
|---|---|---|---|---|---|---|---|
| Group | (μg/d) | (mg/d) | (μg/d) | (mg/d) | (μg/d) | (mg/d) | (mg/d) |
| Infants | | | | | | | |
| 0-6 mo | 400 | 40 | 5 | 4 | 2.0 | 0.2 | 0.3 |
| 7-12 mo | 500 | 50 | 5 | 5 | 2.5 | 0.3 | 0.4 |
| Children | | | | | | | |
| 1-3 y | 300 | 15 | 5 | 6 | 30 | 0.5 | 0.5 |
| 4-8 y | 400 | 25 | 5 | 7 | 55 | 0.6 | 0.6 |

Dietary Reference Intakes (DRIs): Recommended Intakes for Individuals Vitamins
Food and Nutrition Board, Institute of Medicine, National Academies - Part 2

| Life Stage | Niacin | Vit B₆ | Folate | Vit B₁₂ | Pantothenic | Biotin | Choline |
|---|---|---|---|---|---|---|---|
| Group | (mg/d) | (mg/d) | (μg/d) | (μg/d) | Acid (mg/d) | (μg/d) | (mg/d) |
| Infants | | | | | | | |
| 0-6 mo | 2 | 0.1 | 65 | 0.4 | 1.7 | 5 | 125 |
| 7-12 mo | 4 | 0.3 | 80 | 0.5 | 1.8 | 6 | 150 |
| Children | | | | | | | |
| 1-3 y | 6 | 0.5 | 150 | 0.9 | 2 | 8 | 200 |
| 4-8 y | 8 | 0.6 | 200 | 1.2 | 3 | 12 | 250 |

Dietary Reference Intakes (DRIs): Recommended Intakes for Individuals, Elements
Food and Nutrition Board, Institute of Medicine, National Academies - Part 1

| | Calcium | Chromium | Copper | Fluoride | Iodine | Iron |
|---|---|---|---|---|---|---|
| Life Stage Group | (mg/d) | (μg/d) | (mg/d) | (mg/d) | (μg/d) | (mg/d) |
| Infants | | | | | | |
| 0-6 mo | 210 | 0.2 | 200 | 0.01 | 110 | 0.27 |
| 7-12 mo | 270 | 5.5 | 220 | 0.5 | 130 | 11 |
| Children | | | | | | |
| 1-3 y | 500 | 11 | 340 | 0.7 | 90 | 7 |
| 4-8 y | 800 | 15 | 440 | 1 | 90 | 10 |

Dietary Reference Intakes (DRIs): Recommended Intakes for Individuals, Elements
Food and Nutrition Board, Institute of Medicine, National Academies - Part 2

| Life Stage | Magnesium | Manganese | Molybdenum | Phosphorus | Selenium | Zinc | Potassium | Sodium | Chloride |
|---|---|---|---|---|---|---|---|---|---|
| Group | (mg/d) | (mg/d) | (μg/d) | (mg/d) | (μg/d) | (mg/d) | (g/d) | (g/d) | (g/d) |
| Infants | | | | | | | | | |
| 0-6 mo | 30 | 0.003 | 2 | 100 | 15 | 2 | 0.4 | 0.12 | 0.18 |
| 7-12 mo | 75 | 0.6 | 3 | 275 | 20 | 3 | 0.7 | 0.37 | 0.57 |
| Children | | | | | | | | | |
| 1-3 y | 80 | 1.2 | 17 | 460 | 20 | 3 | 3.0 | 1.0 | 1.5 |
| 4-8 y | 130 | 1.5 | 22 | 500 | 30 | 5 | 3.8 | 1.2 | 1.9 |

Dietary Reference Intakes (DRIs): Tolerable Upper Intake Levels (UL), Vitamins
Food and Nutrition Board, Institute of Medicine, National Academies - Part 1

| Life Stage | Vitamin A | Vitamin C | Vitamin D | Vitamin E | Vitamin | | |
|---|---|---|---|---|---|---|---|
| Group | (μg/d)* | (mg/d) | (μg/d) | (mg/d) | K | Thiamin | Riboflavin |
| Infants | | | | | | | |
| 0-6 mo | 600 | ND | 25 | ND | ND | ND | ND |
| 7-12 mo | 600 | ND | 25 | ND | ND | ND | ND |
| Children | | | | | | | |
| 1-3 y | 600 | 400 | 50 | 200 | ND | ND | ND |
| 4-8 y | 900 | 650 | 50 | 300 | ND | ND | ND |

Dietary Reference Intakes (DRIs): Tolerable Upper Intake Levels (UL), Vitamins
Food and Nutrition Board, Institute of Medicine, National Academies - Part 2

| Life Stage | Niacin | Vitamin B | Folate | Vitamin | Pantothenic | | Choline | |
|---|---|---|---|---|---|---|---|---|
| Group | (mg/d) | (mg/d) | (μg/d) | B₁₂ | Acid | Biotin | (g/d) | Carotenoids |
| Infants | | | | | | | | |
| 0-6 mo | ND | ND | ND | ND | ND | ND | ND | ND |
| 7-12 mo | ND | ND | ND | ND | ND | ND | ND | ND |
| Children | | | | | | | | |
| 1-3 y | 10 | 30 | 300 | ND | ND | ND | 1.0 | ND |
| 4-8 y | 15 | 40 | 400 | ND | ND | ND | 1.0 | ND |

Dietary Reference Intakes (DRIs): Tolerable Upper Intake Levels (UL), Elements
Food and Nutrition Board, Institute of Medicine, National Academies - Part 1

| | | | Cal- | | | | | | | |
|---|---|---|---|---|---|---|---|---|---|---|
| Life Stage | | Boron | cium | Copper | | Fluoride | Iodine | Iron | Magnesium | Manganese |
| Group | Arsenic | (mg/d) | (g/d) | (μg/d) | Chromium | (mg/d) | (μg/d) | (mg/d) | (mg/d) | (mg/d) |
| Infants | | | | | | | | | | |
| 0-6 mo | ND | ND | ND | ND | ND | 0.7 | ND | 40 | ND | ND |
| 7-12 mo | ND | ND | ND | ND | ND | 0.9 | ND | 40 | ND | ND |
| Children | | | | | | | | | | |
| 1-3 y | ND | 3 | 2.5 | ND | 1,000 | 1.3 | 200 | 40 | 65 | 2 |
| 4-8 y | ND | 6 | 2.5 | ND | 3,000 | 2.2 | 300 | 40 | 110 | 3 |

Dietary Reference Intakes (DRIs): Tolerable Upper Intake Levels (UL), Elements
Food and Nutrition Board, Institute of Medicine, National Academies - Part 2

| | | | Phos- | | Sele- | | | | | | |
|---|---|---|---|---|---|---|---|---|---|---|---|
| Life Stage | Molybdenum | Nickel | phorus | Potas- | nium | Sili- | | Vanadium | Zinc | Sodium | Chloride |
| Group | (μg/d) | (mg/d) | (g/d) | sium | (μg/d) | cone | Sulfate | (mg/d) | (mg/d) | (g/d) | (g/d) |
| Infants | | | | | | | | | | | |
| 0-6 mo | ND | ND | ND | ND | 45 | ND | ND | ND | 4 | ND | ND |
| 7-12 mo | ND | ND | ND | ND | 60 | ND | ND | ND | 5 | ND | ND |
| Children | | | | | | | | | | | |
| 1-3 y | 300 | 0.2 | 3 | ND | 90 | ND | ND | ND | 7 | 1.5 | 2.3 |
| 4-8 y | 600 | 0.3 | 3 | ND | 150 | ND | ND | ND | 12 | 1.9 | 2.9 |

Dietary Reference Intakes (DRIs):
Acceptable Macronutrient Distribution Ranges
Food and Nutrition Board, Institute of Medicine, National Academies

| | Range (percent of energy) | | |
|---|---|---|---|
| Macronutrient | Children, 1-3 y | Children, 4-18 y | Adults |
| Fat | 30-40 | 25-35 | 20-35 |
| n-6 polyunsaturated fatty | 5-10 | 5-10 | 5-10 |
| acids (linoleic acid) | | | |
| n-3 polyunsaturated fatty | 0.6-1.2 | 0.6-1.2 | 0.6-1.2 |
| acids (α-linolenic acid) | | | |
| Carbohydrate | 45-65 | 45-65 | 45-65 |
| Protein | 5-20 | 10-30 | 10-35 |

Dietary Reference Intakes (DRIs): Recommended Intakes for Individuals, Macronutrients
Food and Nutrition Board, Institute of Medicine, National Academies

| Life Stage | Total Water | Carbohydrate | Total Fiber | Fat | Linoleic Acid | α-Linolenic | Protein |
|---|---|---|---|---|---|---|---|
| Group | (L/d) | (g/d) | (g/d) | (g/d) | (g/d) | Acid (g/d) | (g/d) |
| Infants | | | | | | | |
| 0-6 mo | 0.7 | 60 | ND | 31 | 4.4 | 0.5 | 9.1 |
| 7-12 mo | 0.8 | 95 | ND | 30 | 4.6 | 0.5 | 11.0 |
| Children | | | | | | | |
| 1-3 y | 1.3 | 130 | 19 | ND | 7 | 0.7 | 13 |
| 4-8 y | 1.7 | 130 | 25 | ND | 10 | 0.9 | 19 |

Dietary Reference Intakes (DRIs): Tolerable Upper Intake Levels (UL), Elements
Food and Nutrition Board, Institute of Medicine, National Academies - Part 1

| | | | | | | | Ribo- | | | |
|---|---|---|---|---|---|---|---|---|---|---|
| Life Stage | CHO | Protein | Vit A | Vit C | Vit E | Thiamin | flavin | Niacin | Vit B₆ | Folate |
| Group | (g/d) | (g/d) | (μg/d) | (mg/d) | (mg/d) | (mg/d) | (mg/d) | (mg/d) | (mg/d) | (μg/d) |
| Infants | | | | | | | | | | |
| 7-12 mo | | 9 | | | | | | | | |
| Children | | | | | | | | | | |
| 1-3 y | 100 | 11 | 210 | 13 | 5 | 0.4 | 0.4 | 5 | 0.4 | 120 |
| 4-8 y | 100 | 15 | 275 | 22 | 6 | 0.5 | 0.5 | 6 | 0.5 | 160 |

Dietary Reference Intakes (DRIs): Tolerable Upper Intake Levels (UL), Elements
Food and Nutrition Board, Institute of Medicine, National Academies - Part 2

| | | | | | | | Phos- | | |
|---|---|---|---|---|---|---|---|---|---|
| Life Stage | Vit B₁₂ | Copper | Iodine | Iron | Magnesium | Molybdenum | phorus | Selenium | Zinc |
| Group | (μg/d) | (μg/d) | (μg/d) | (mg/d) | (mg/d) | (μg/d) | (mg/d) | (μg/d) | (mg/d) |
| Infants | | | | | | | | | |
| 7-12 mo | | | | 6.9 | | | | | 2.5 |
| Children | | | | | | | | | |
| 1-3 y | 0.7 | 260 | 65 | 3.0 | 65 | 13 | 380 | 17 | 2.5 |
| 4-8 y | 1.0 | 340 | 65 | 4.1 | 110 | 17 | 405 | 23 | 4.0 |

With the above nutritional guidelines in mind, and the host of problems associated with meeting the dietary needs of youngsters, Applicant envisioned the improvements of the instant invention. The present invention provides a range of daily feeding schedules for children comprising suggested combinations of food products from a range of baby food having an optimal nutrition profile for meeting the nutritional needs of a child. Two or more food products from the range may be combined to provide an optimal nutrition profile for meeting the nutritional needs of a child.

The children range up to age five, preferably between one and five years of age and most preferably from one to four years of age.

The total optimal daily nutrition profile for each of the food products is determined by first evaluating and determining the caloric needs for the children's population group since calories are the basis for other macronutrient needs. Using calories as the basis, the missing Daily Values are determined for fat, saturated fat, trans fat, sodium, cholesterol, fiber and sugar. The nutrition profile is then further distilled for individual foods as well as meals, facilitating the care and creating a methodology on the feeding of youngsters.

### Calories

As a first threshold, energy is needed for toddler growth and development. Energy balance is important to maintain proper growth and development, which is dependent on energy intake and expenditure. The Estimated Energy Requirement (EER) used by the Institute of Medicine is the average daily energy intake predicted to maintain energy balance in healthy adults and is defined by age, gender, weight, height and level of physical activity. The EER for toddlers includes energy needs for growth and development during this time. This EER allows for individual variability. The IOM, however, did not set RDAs or ULs for calories for any groups because any intakes above the EER are expected to result in weight gain.

The chart below outlines the caloric needs of toddlers of varying ages, which as is apparent varies considerably by age and gender.

| | | 24-36 mos. | | 36-48 mos. | 36-48 mos. |
|---|---|---|---|---|---|
| | | All Activity | 36-48 mos. | Moderately | Very |
| Organization | 12-24 mos. | Levels | Sedentary | Active | Active |
| EER- | 768-997 | 997-1080 | 1080 | 1395 | 1649 |
| females | | | | | |
| EER-males | 844-1050 | 1050-1162 | 1162 | 1485 | 1683 |
| AHA- | 900 | 1000 | 1000 | 1200 | 1400 |
| females | | | | | |
| AHA-males | 900 | 1000 | 1000 | 1200 | 1400 |
| MyPyramid- | — | 1000 | 1000 | 1200 | 1400 |
| females | | | | | |
| MyPyramid- | — | | | | |
| males | | 1000 | 1200 | 1400 | 1400 |

With the above figures in mind, some guidelines can be proposed to simplify calculations and facilitate usage of the figures.

Toddler Dietary Guideline for Calories: 1050 (1000).

Average EER of females and males at 24 months=1024.

Average EER of females and males at 36 months=1121.

Average of 24 and 36 month EERs=1072.

Rounded average EER and American Heart Association (AHA) and American Academy of Pediatrics (AAP) calories for females and males at 12-24 months=900.

Moderately active AHA/AAP calories for females and males 36-48 months=1200.

Average of 12-48 month calories=1050.

Toddler Dietary Guidelines for calories=1000.

### Fat

Turning now to another essential dietary component for toddlers, total fat is calculated based on the midpoint between the AHA and AAP range from 12-48 months without rounding down the amount because toddlers need fat in their diets.

Applicants have found that a total optimal daily nutrition profile for each of the food products, comprising about 41 g fat, about 300 mg cholesterol, about 12 g saturated fat and about 1500 mg sodium, constitutes a preferred guideline for practicing the principles of the present invention. The total optimal daily nutrition profile further comprises about 16 g fiber.

### Example

Applicants have gathered data regarding the present invention and set forth in the chart below an exemplary dietary regimen with a breakdown between the constituent parts.

### Example

| | Toddler Daily | | |
|---|---|---|---|
| Nutrient | Guidelines | Single Foods | Meals/Main Dishes |
| Calories | 1050 Kcal | 90-130 | 180 |
| | | (260 kcal/day/2 = 130 | (25% of 1050- milk) |
| | | and 260/3 = 90) | |
| Fat | 41 g (35%) | 4 g | 6-7 g |
| | | (10% Daily Guideline) | (30-35% of 180 kcal) |
| Saturated | 12 g (10%) | 1 g | 2 g |
| Fat | | (10% Daily Guideline) | (10% of 180 kcal) |
| | | | (meal 25% kcal-milk kcal) |
| Sodium | 1500 mg | 225 mg | 380 mg |
| | (AAP/AHA DRI UL) | (15% of 1500) | (396-⅔ adult 600 mg/SS; |
| | | | 375-25% of 1500) |
| Cholesterol | 300 mg | 40 mg | 60 mg |
| | | (300 × ⅔ × 20%) | (20% of 300 mg) |
| Trans Fat | <2% kcal | | |
| Added Sugars | 30 g (12% of kcal) | 5 g | 7 g |
| Fiber, Protein, | Fiber 16 g | 10% Daily Guideline | 10% of Daily Guideline |
| Vitamins A, C, | (⅔ of adult 25 g) | | for 2 for main dish and 3 |
| Calcium, Iron, | DVs for others | | for meal. |
| Vitamin E, Potassium | | | 8 g of whole grain, |
| Whole grain, dairy, | | 2 g whole grain, | nutrition of 1 oz yogurt, |
| fruit, vegetables, | | nutrition of 1 oz. | ¼-⅓ cup fruit/vegetable, |
| Omega 3 oils. | | yogurt, ¼-⅓ | 10% DRI Omega 3 oils. |
| | | cup fruit/vegetable, | |
| | | 10% DRI Omega 3 oils. | |

As described hereinabove, feeding schedules comprise Complete meals or a number of Incomplete meals. The Complete meals comprise two or more Incomplete meals, the combination of which meets the dietary needs of a toddler.

In use, a parent or caregiver would consult a caloric reference and a daily food component reference and determine a nutritious diet for a child. It should be understood that the improved paradigm of the present invention facilitates the proper care and feeding of a child by better managing the diverse nutritional needs for a child, enabling a harried parent or caregiver to handle this stress better and alleviate worry. Through color-coding and other visual clues, the different food groups can be constituted into meals or portions thereof for simplifying this process even further, e.g., food group portions can be enclosed in the aforementioned color-coded containers, e.g., caloric load and food group, allowing the flexibility to mix and match. Furthermore, particular color and/or configuration combinations can be employed to facilitate a full daily regimen for the child, assuring a rounded and healthy intake of nourishment.

The term “about,” as used herein, should generally be understood to refer to both numbers in a range of numerals. Moreover, all numerical ranges herein should be understood to include each whole integer within the range. Throughout this application, the term “about” is also used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

The terms “a” and “an,” when used in conjunction with the word “comprising” in the claims or specification, denotes one or more, unless specifically noted.

It is to be understood that the invention is not to be limited to the exact methodology described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A nutrition method for optimizing the nutritional needs of a child, comprising:
ascertaining a caloric requirement for said child, said caloric requirement based at least on the age of said child; and
combining, from a selection of daily food components on a daily food component reference, at least two of said daily food components,
wherein said daily food components, each having a respective nutritional profile associated therewith, are selected from the group consisting of fat, saturated fat, trans fat, sodium, cholesterol, fiber and sugar, and
wherein the combination of said at least two daily food components have a caloric load about that of said caloric requirement for a meal for said child,
whereby the selection and combining of the daily food components optimize the nutritional needs of said child.

2. The method according to claim 1, wherein said child is up to about five (5) years of age.

3. The method according to claim 2, wherein said child is between one and five years of age.

4. The method according to claim 3, wherein said child is between one and four (4) years of age.

5. The method according to claim 1, wherein said daily food components combined include fat, saturated fat, sodium and cholesterol.

6. The method according to claim 5, wherein said fat is about 41 gm, said saturated fat is about 12 g, said sodium is about 1500 mg and said cholesterol is about 300 mg.

7. The method according to claim 1, wherein said daily food components combined include fiber.

8. The method according to claim 7, wherein said fiber is about 16 g.

9. The method according to claim 1, wherein in said step of combining, the selection of at least two of said daily food components comprises an incomplete meal.

10. The method according to claim 1, wherein in said step of combining, the selection of at least two of said daily food components comprises a complete meal.

11. The method according to claim 10, wherein said complete meal comprises at least two incomplete meals.

12. A kit for optimizing the nutritional needs of a child, comprising:
a caloric reference, said caloric reference providing a user with a caloric requirement for said child, said caloric requirement based at least on the age of said child; and
a daily food component reference, said daily food component reference providing said user with a selection of daily food components, at least two of said daily food components being combined,
wherein said daily food components, each having a respective nutritional profile associated therewith, are selected from the group consisting of fat, saturated fat, trans fat, sodium, cholesterol, fiber and sugar, and
wherein the combination of said at least two daily food components have a caloric load about that of said caloric requirement for a meal of said child,
whereby the selection and combining of the daily food components optimize the nutritional needs of said child.

13. The kit according to claim 12, wherein said child is up to about five (5) years of age.

14. The kit according to claim 13, wherein said child is between one and five years of age.

15. The kit according to claim 14, wherein said child is between one and four (4) years of age.

16. The kit according to claim 12, wherein said daily food components combined include fat, saturated fat, sodium and cholesterol.

17. The kit according to claim 16, wherein said fat is about 41 gm, said saturated fat is about 12 g, said sodium is about 1500 mg and said cholesterol is about 300 mg.

18. The kit according to claim 12, wherein said daily food components combined include fiber.

19. The kit according to claim 18, wherein said fiber is about 16 g.

20. The kit according to claim 12, wherein in said step of combining, the selection of at least two of said daily food components comprises an incomplete meal.

21. The kit according to claim 12, wherein in said step of combining, the selection of at least two of said daily food components comprises a complete meal.

22. The kit according to claim 21, wherein said complete meal comprises at least two incomplete meals.

23. The kit according to claim 12, wherein said caloric reference, said daily food component reference and said daily food components employ a plurality of colors and configurations.

24. A shelf-stable food product for a child, comprising:
a caloric reference, said caloric reference providing a user with a caloric requirement for said child, said caloric requirement based at least on the age of said child, said food product including an indicia of the calories of said food product; and
a daily food component reference, said daily food component reference providing said user with a selection of daily food components, at least two of said daily food components being combined in said food product,
wherein said daily food components, each having a respective nutritional profile associated therewith, are selected from the group consisting of fat, saturated fat, trans fat, sodium, cholesterol, fiber and sugar, and
wherein the combination of said at least two daily food components in said food product have a caloric load about that of said caloric requirement for a meal of said child,
whereby the selection and combining of the daily food components optimize the nutritional needs of said child.

25. The shelf-stable food product according to claim 24 wherein said child is up to about five (5) years of age.

26. The shelf-stable food product according to claim 25 wherein said child is between one and five years of age.

27. The shelf-stable food product according to claim 26 wherein said child is between one and four (4) years of age.

28. The shelf-product according to claim 24 wherein said daily food components combined include fat, saturated fat, sodium and cholesterol.

29. The shelf-stable food product according to claim 28 wherein said fat is about 41 gm, said saturated fat is about 12 g, said sodium is about 1500 mg and said cholesterol is about 300 mg.

30. The shelf-stable food product according to claim 24, wherein said daily food components combined include fiber.

31. The shelf-stable food product according to claim 30, wherein said fiber is about 16 g.

32. The shelf-stable food product according to claim 24, wherein in said step of combining, the selection of at least two of said daily food components comprises an incomplete meal.

33. The shelf-stable food product according to claim 24, wherein in said step of combining, the selection of at least two of said daily food components comprises a complete meal.

34. The shelf-stable food product according to claim 33, wherein said complete meal comprises at least two incomplete meals.

35. The shelf-stable food product according to claim 24, wherein said caloric reference, said daily food component reference and said daily food components employ a plurality of colors and configurations.
